(19) United States
(12) Patent Application Publication
(10) Pub. No.: US 2026/0133318 A1
(43) Pub. Date: May 14, 2026

(54) IMAGE SENSING DEVICE

(71) Applicant: SK hynix Inc., Icheon-si Gyeonggi-do (KR)

(72) Inventors: Da Hwan PARK, Icheon-si Gyeonggi-do (KR); Min Kyu KIM, Icheon-si Gyeonggi-do (KR); Han Sang KIM, Icheon-si Gyeonggi-do (KR); Gun Hee YUN, Icheon-si Gyeonggi-do (KR); Yong Seop LEE, Icheon-si Gyeonggi-do (KR); Ji Ho LEE, Icheon-si Gyeonggi-do (KR); Hoe Sam JEONG, Icheon-si Gyeonggi-do (KR)

(73) Assignee: SK hynix Inc., Icheon-si Gyeonggi-do (KR)

(21) Appl. No.: 19/322,254

(22) Filed: Sep. 8, 2025

(30) Foreign Application Priority Data
Nov. 13, 2024 (KR) 10-2024-0161277

(51) Int. Cl. G01S 17/89; G01S 7/4865; G01S 17/10; G06T 7/521; G06T 7/55

(52) U.S. Cl. CPC G01S 17/89; G01S 7/4865; G01S 17/10; G06T 7/521; G06T 7/55; G06T 2207/20072; G06T 2207/20224

(57) ABSTRACT

An image sensing device includes a pulse signal generator that generates a first pulse signal having a first pulse width and a second pulse signal having a second pulse width; a laser pulse transmitter that transmits a first laser pulse based on the first pulse signal and a second laser pulse based on the second pulse signal; a reflected pulse receiver that receives a first reflected pulse when the first laser pulse is reflected from an object and a second reflected pulse when the second laser pulse is reflected from the object, and generate first image data and second image data based on the reflected pulses; and a distance information generator that generates a first histogram based on the first image data, a second histogram based on the second image data, and distance information for the object based on a difference between the first histogram and the second histogram.

### CROSS REFERENCE TO RELATED APPLICATION

The present application claims priority under 35 U.S.C. § 119 (a) to Korean patent application No. 10-2024-0161277, filed in the Korean Intellectual Property Office on Nov. 13, 2024, the entire contents of which application is incorporated herein by reference.

### 1. TECHNICAL FIELD

The present disclosure generally relates to an image sensing device.

### 2. RELATED ART

An image sensing device is a device that captures optical images by converting light into electrical signals using a photosensitive semiconductor material that reacts to light. With the development of automotive, medical, computer, and communication industries, the demand for high-performance image sensing devices is increasing in various fields such as smartphones, digital cameras, game machines, Internet of Things (IoT), robots, security cameras, and medical micro cameras.

Recently, image sensing devices are actively used to acquire color images and to sense the distance to a target object whose object is captured. A time of flight (ToF) method, which directly or indirectly measures a time duration in which light is reflected from the target object and returns to the image sensing device, is widely used.

### SUMMARY

In accordance with an embodiment of the present disclosure, an image sensing device may include: a pulse signal generator configured to generate a first pulse signal having a first pulse width and a second pulse signal having a second pulse width; a laser pulse transmitter configured to transmit a first laser pulse based on the first pulse signal and transmit a second laser pulse based on the second pulse signal; a reflected pulse receiver configured to receive a first reflected pulse generated when the first laser pulse is reflected from an object and a second reflected pulse generated when the second laser pulse is reflected from the object and generate first image data and second image data based on the first reflected pulse and the second reflected pulse, respectively; and a distance information generator configured to generate a first histogram based on the first image data, generate a second histogram based on the second image data, and generate distance information for the object based on a difference between the first histogram and the second histogram.

In accordance with an embodiment of the present disclosure, an image sensing device may include: a laser pulse transmitter configured to transmit laser pulses; a reflected pulse receiver configured to receive reflected pulses generated when the laser pulses are reflected from an object; a time information generator configured to generate first time information indicating a time elapsed from a first time to a reception time of the reflected pulse based on a first clock signal at a first phase and generate second time information indicating a time elapsed from a second time, which is subsequent to the first time, to a reception time of the reflected pulse based on the second clock signal at a second phase; and a distance information generator configured to generate histograms based on the first time information and the second time information, and generate distance information for the object based on the histograms.

In accordance with an embodiment of the present disclosure, an image processing device may include: a division signal generator configured to generate division signals by dividing clock signals; a pulse width controller configured to generate a first pulse width control signal and a second pulse width control signal; a first multiplexer configured to select any one of the division signals based on the first pulse width control signal; a second multiplexer configured to select any one of inverted division signals obtained by inversion of the division signals based on the first pulse width control signal; a shift register configured to generate latch signals based on the second pulse width control signal, a selected division signal, and a selected inverted division signal; a third multiplexer configured to select any one of the latch signals based on the first pulse width control signal; an inverter configured to invert the selected latch signal; an AND gate configured to output a pulse signal by performing a logical AND operation on the inverted latch signal and the second pulse width control signal; a laser pulse transmitter configured to transmit laser pulses based on the pulse signal; and a reflected pulse receiver configured to receive reflected pulses generated when the laser pulses are reflected from an object and generate image data based on the reflected pulses.

In accordance with an embodiment of the present disclosure, a method may include generating a first pulse signal having a first pulse width and a second pulse signal having a second pulse width; transmitting, by an image sensing device, a first laser pulse based on the first pulse signal and transmit a second laser pulse based on the second pulse signal; generating first image data based on a first received reflected pulse reflected from an object; generating second image data based on a second received reflected pulse reflected from an object; and generating a first histogram based on the first image data, generating a second histogram based on the second image data, and generate distance information for the object based on a difference between the first histogram and the second histogram.

### BRIEF DESCRIPTION OF THE DRAWINGS

FIG. 1 is a block diagram illustrating an image sensing device according to an embodiment of the present disclosure.

FIG. 2 is a block diagram illustrating an image sensing device according to an embodiment of the present disclosure.

FIG. 3 is a circuit diagram illustrating a division signal generator according to an embodiment of the present disclosure.

FIG. 4 is a timing diagram of division signals according to an embodiment of the present disclosure.

FIG. 5 is a circuit diagram illustrating a pulse signal generator according to an embodiment of the present disclosure.

FIG. 6 is a timing diagram during operation of the image sensing device according to an embodiment of the present disclosure.

FIG. 7 includes histograms generated during a method of operating the image sensing device according to an embodiment of the present disclosure.

FIG. 8 is a block diagram illustrating an image sensing device according to an embodiment of the present disclosure.

FIG. 9 is a block diagram illustrating an image sensing device according to an embodiment of the present disclosure.

FIG. 10 is a diagram illustrating a time-to-digital converter of an image sensing device according to an embodiment of the present disclosure.

FIG. 11 is a timing diagram during a method of operating the image sensing device according to an embodiment of the present disclosure.

FIG. 12 is a timing diagram including histograms generated during a method of operating the image sensing device according to an embodiment of the present disclosure.

FIG. 13 is a block diagram illustrating an image sensing device according to an embodiment of the present disclosure.

FIG. 14 is a diagram illustrating a time-to-digital converter of an image sensing device according to an embodiment of the present disclosure.

### DETAILED DESCRIPTION

The present disclosure describes an image sensing device that may be used in configurations to substantially address one or more technical or engineering issues and to mitigate limitations or disadvantages encountered in some other image sensing devices. The present disclosure relates to an image sensing device that can control a pulse width of a laser pulse. The present disclosure relates to an image sensing device that can acquire accurate distance information by generating a histogram corresponding to a difference between reflected pulses reflected from a target object. The present disclosure relates to an image sensing device that can generate histograms using clock signals having a phase difference. The present disclosure relates to an image sensing device that can acquire accurate distance information by generating a combined histogram by combining histograms. The present disclosure describes an image sensing device that may control a pulse width of a transmitted (Tx) laser pulse. The present disclosure describes an image sensing device that may acquire accurate distance information by generating a histogram corresponding to a difference in reflected pulses. The present disclosure describes an image sensing device that may generate histograms using clock signals having a phase difference. The present disclosure describes an image sensing device that may acquire accurate distance information by generating a combined histogram by combining histograms.

Embodiments of the present disclosure are described in detail with reference to the accompanying drawings. Specific structural or functional descriptions of embodiments are provided as examples to describe concepts that are disclosed in the present application. Examples or embodiments in accordance with the concepts may be carried out in various forms, and the scope of the present disclosure is not limited to the examples or embodiments described in this specification.

Terms such as “first” and “second” are used to distinguish between various elements and do not imply size, order, priority, quantity, or importance of the elements. For example, a first element may be referred to as a second element in one example, and the second element may be referred to as a first element in another example.

Terms such as “high,” “column,” and “row,” and other terms implying relative spatial relationship or orientation are utilized only for the purpose of ease of description or reference to a drawing and are not otherwise limiting.

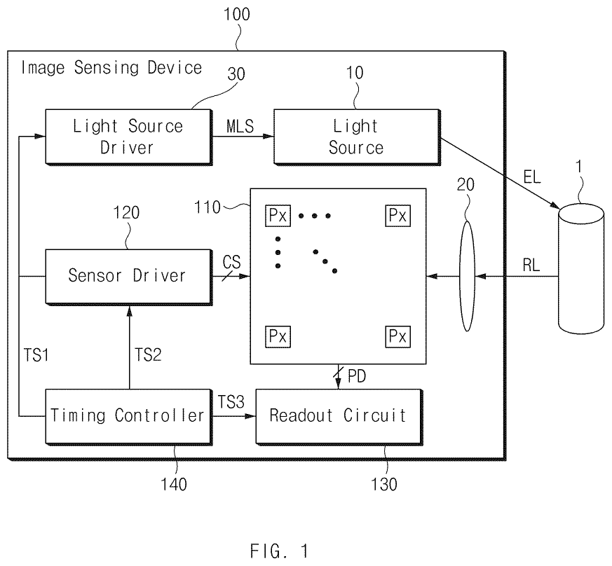

FIG. 1 is a block diagram illustrating an example of an image sensing device 100 according to an embodiment of the present disclosure.

Referring to FIG. 1, the image sensing device 100 is a device, for example, a digital still camera that photographs still images or a digital video camera that photographs moving images. For example, the image sensing device 100 may be a Digital Single Lens Reflex (DSLR) camera, a mirrorless camera, or a smartphone, and so forth. The image sensing device 100 includes a device having a lens and an image pickup element such that the device can capture or photograph a target object and create an image of the target object. For example, the image sensing device 100 may be a Lidar sensor.

The image sensing device 100 may be a complementary metal oxide semiconductor image sensor CIS for converting an incident light into an electrical signal. The image sensing device 100 may include a light source 10, a lens module 20, a light source driver 30, a pixel array 110, a sensor driver 120, a readout circuit 130, a timing controller 140, and so forth. The components of the image sensing device 100 illustrated in FIG. 1 are described as an example.

The light source 10 emits light toward a target object 1 upon receiving a modulation light signal MLS from the light source driver 30. The light source 10 may be a laser diode (LD) or a light emitting diode (LED) that emits light, such as near infrared (NIR) light, infrared (IR) light or visible light, in a specific wavelength band or may be one of an NIR, a point light source, a monochromatic light source combined with a white lamp or a monochromator, and a combination of other laser sources. For example, the light source 10 may emit infrared light having a wavelength of 800 nm to 1000 nm. Light emitted from the light source 10 may be pulsed light having a predetermined period, amplitude, and pulse width. Although FIG. 1 shows only one light source 10, the present disclosure is not limited to this example, and a plurality of light sources may be arranged around or in the vicinity of the lens module 20.

The lens module 20 collects light reflected from the target object 1 and focuses the collected light onto pixels PXs of the pixel array 110. For example, the lens module 20 includes a focusing lens having a surface formed of glass or plastic or a cylindrical optical element having a surface formed of glass or plastic. The lens module 20 may include a plurality of lenses arranged to focus on an optical axis.

The light source driver 30 generates the modulation light signal MLS that drives the light source 10 in response to a timing signal TS1 from the timing controller 140. For example, the light source driver 30 controls characteristics of waveforms, such as a period, amplitude, pulse width, and so forth, of emitted light EL output from the light source 10.

The pixel array 110 includes a plurality of pixels PXs arranged in a two-dimensional 2D matrix structure, such as arranged in a column direction and/or a row direction. Each of the plurality of pixels PXs generates a pixel signal by sensing incident light received through the lens module 20 under control of the sensor driver 120. The pixel array 110 may include a color filter array CFA in which color filters are arranged according to a predetermined pattern, such as a Bayer pattern, a quad-Bayer pattern, nona-Bayer pattern, an RGBW pattern, and so forth, such that each color filter senses light within a predetermined wavelength band. The pattern of the image data IDATA may be determined according to the type of the pattern of the CFA.

Each pixel PX may be an infrared pixel that generates pixel data PD by sensing incident light that includes reflected light RL generated when emitted light EL from the light source 10 is reflected from the target object 1. The present disclosure is not limited to the example that the reflected light RL is light reflected from the target object 1 and incident upon the pixel array 110. In an embodiment, the infrared pixel is a depth pixel that generates data used to calculate the distance to the target object 1. According to an embodiment, the infrared pixel includes a pixel that generates an infrared image by sensing infrared light incident from a scene without sensing reflected light. According to an embodiment, the pixels PXs include a pixel that generate a color image by sensing visible light incident from a scene. According to an embodiment, the pixel PX include a single-photon avalanche diode SPAD pixel.

The sensor driver 120 drives the pixels PXs of the pixel array 110 in response to a timing signal TS1 output from the timing controller 140. For example, the sensor driver 120 generates a control signal CS utilized to select and control pixels PXs included in at least one row line from among a plurality of row lines of the pixel array 110.

The readout circuit 130 processes pixel signals received from the pixel array 110 according to a timing signal TS3 from the timing controller 140 and generates and stores image data IDATA utilized to detect the distance to the target object 1. The image data IDATA may be digital data obtained by performing analog-to-digital conversion ADC on an analog pixel signal. The readout circuit 130 includes a correlated double sampler CDS circuit that performs correlated double sampling CDS on the pixel signals generated from the pixel array 110. The readout circuit 130 may include an analog-to-digital converter ADC that converts output signals from the CDS circuit into digital signals. The readout circuit 130 includes a buffer circuit that temporarily stores pixel data generated from the analog-to-digital converter ADC and outputs the pixel data under control of the timing controller 140. Two column lines that transmit pixel signals are included for each column of the pixel array 110, and structures that process the pixel signals generated from each column line correspond to each column line.

The timing controller 140 generates timing signals TS1, TS2, TS3 to control the light source driver 30, the sensor driver 120, and the readout circuit 130. In an embodiment, the timing controller 140 generates a timing signal according to either a predetermined setting value and/or a request received from an image processing device 200. For example, the timing controller 140 may include a logic control circuit, a phase lock loop PLL circuit, a timing control circuit, a communication interface circuit, and so forth.

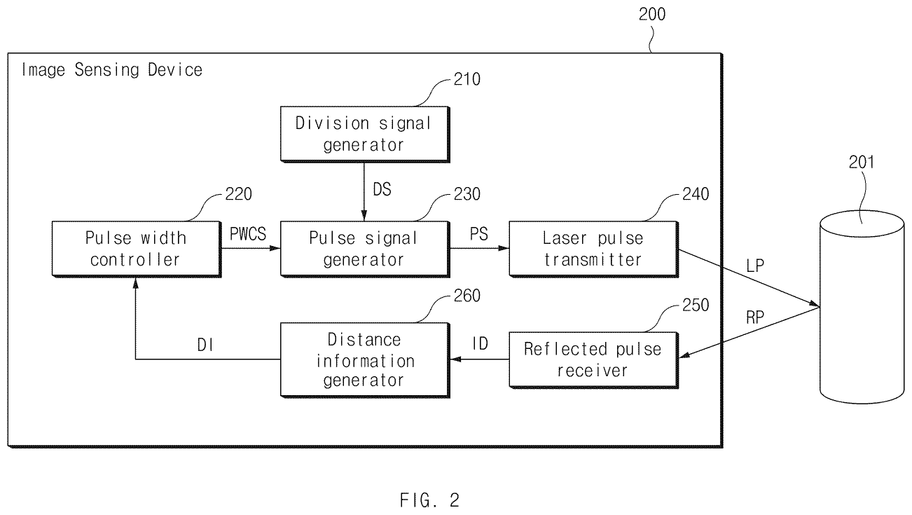

FIG. 2 is a block diagram illustrating an image sensing device according to an embodiment of the present disclosure.

Referring to FIG. 2, the image sensing device 200 according to an embodiment of the present disclosure includes a division signal generator 210, a pulse width controller 220, a pulse signal generator 230, a laser pulse transmitter 240, a reflected pulse receiver 250, and a distance information generator 260. The image sensing device 200 of FIG. 2 may correspond to the image sensing device 100 of FIG. 1.

The division signal generator 210 generates division signals DS by dividing clock signals. For example, when a frequency of the clock signal is 1 GHZ, a frequency of the division signals DS includes 500 MHz, 250 MHz, and so forth. The frequencies of the clock signals and the division signals DS are not limited to these examples. The division signals DS may be considered to be clock signals. The generated division signals DS are input to the pulse signal generator 230, and the pulse signal generator 230 generate pulse signals PS based on the division signals DS. Although not shown in FIG. 2, the image sensing device 200 may include a clock signal generator. For example, the image sensing device 200 may include a voltage-controlled oscillator VCO.

The pulse width controller 220 controls a pulse width of the pulse signals PS generated by the pulse signal generator 230. For example, the pulse width controller 220 generates pulse width control signals PWCS. For example, the pulse width controller 220 generates a first pulse width control signal and a second pulse width control signal. The generated pulse width control signals PWCS are input to the pulse signal generator 230. The pulse width controller 220 may be a timing generator. Alternatively, the pulse width controller 220 may correspond to the timing controller 140 of FIG. 1.

The pulse signal generator 230 generates pulse signals PS. For example, the pulse signal generator 230 generates the pulse signals PS based on the division signals DS and the pulse width control signals PWCS. For example, the pulse signal generator 230 generates a first pulse signal having a first pulse width and a second pulse signal having a second pulse width, based on the division signals DS and the pulse width control signals PWCS. The pulse signals PS are signals utilized to determine a pulse width of a laser pulse.

The laser pulse transmitter 240 generates laser pulses LP based on the pulse signals PS and transmits the laser pulses to a target object. For example, the laser pulse transmitter 240 transmits a first laser pulse to the target object based on a first pulse signal and transmits a second laser pulse to the target object based on a second pulse signal. Pulse widths of the laser pulses LP transmitted by the laser pulse transmitter 240 are determined based on the input pulse signals PS. Accordingly, because the pulse widths of the first and second pulse signals are different from each other, the pulse width of the first laser pulse is different from the pulse width of the second laser pulse. For example, the laser pulse transmitter 240 transmits a laser pulse LP having a pulse width proportional to the pulse width of the input pulse signal PS. The transmitted Tx laser pulses LP are reflected by the target object 201 and become reflected pulses RP. The laser pulse transmitter 240 may correspond to the light source 10 and the light source driver 30 of FIG. 1.

The reflected pulse receiver 250 receives reflected pulses RP generated by the laser pulses LP and reflected from or off the target object 201. For example, the reflected pulse receiver 250 receives a first reflected pulse generated by the first laser pulse reflected from the target object 201, and a second reflected pulse generated by the second laser pulse reflected from the target object 201. The reflected pulse receiver 250 may generate image data ID based on the received reflected pulses RP. For example, the reflected pulse receiver 250 generates first image data based on the first reflected pulse and generates second image data based on the second reflected pulse. The reflected pulse receiver 250 may correspond to the pixel array 110 and the readout circuit 130 of FIG. 1.

The distance information generator 260 generates a histogram based on image data ID. For example, the distance information generator 260 generates a first histogram based on the first image data and generates a second histogram based on the second image data. The distance information generator 260 generates a histogram based on the image data ID. For example, the distance information generator 260 generates a first histogram based on the first image data and generate a second histogram based on the second image data. For example, the histogram includes a bin number denoted on the X-axis and a count value of laser pulses denoted on the Y-axis. The bin number corresponds to time taken between emitting a laser pulse and receiving a reflected pulse as reflected by the target object. The distance information generator 260 generates distance information DI based on the histogram. For example, the distance information generator 260 generates distance information DI for the target object based on a difference between a first histogram and a second histogram. For example, the distance information generator 260 generates a difference histogram for a difference pulse, which is a difference between the first reflected pulse and the second reflected pulse, by calculating a difference between the first histogram and the second histogram and generating distance information D using time information corresponding to a peak count value of the difference histogram. In an embodiment, because the Y-axis of the histogram corresponds to the count value of laser pulses, the distance information generator 260 calculates the distance to the target object using the speed of light and time information corresponding to the bin number having the peak count value.

The pulse width controller 220 changes or varies pulse width control signals. For example, the pulse width controller 220 may change the pulse width control signals based on the distance information DI generated by the distance information generator 260. For example, the distance to an object s inversely proportional to the intensity of the reflected pulse received by the reflected pulse receiver 250. Accordingly, when a first object is located at a first distance from a reference point for distance measurement and a second object is located at a second distance farther than the first distance, transmitting to the second object a laser pulse having a larger pulse width than the width of the laser pulse transmitted to the first object may provide more accurate distance measurement.

Therefore, the pulse width controller 220 adaptively changes the pulse width control signals based on the distance information DI, and the pulse signal generator 230 generates pulse signals having different pulse widths based on the changed or modified pulse width control signals. As a result, the laser pulse transmitter 240 transmits laser pulses having different pulse widths to the object. For example, the pulse width controller 220 generates pulse width control signals that control the pulse signal generator 230 such that the first and second pulse widths can increase when the object is located farther away based on the distance information DI.

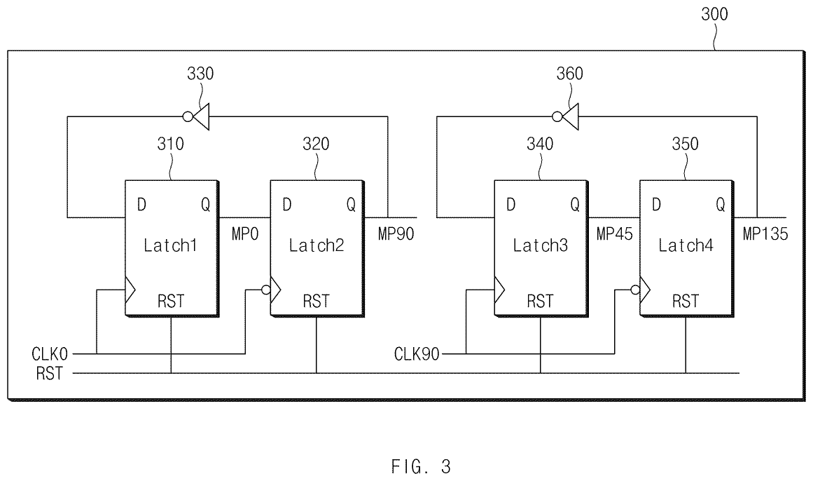

FIG. 3 is a circuit diagram illustrating a division signal generator 300 according to an embodiment of the present disclosure.

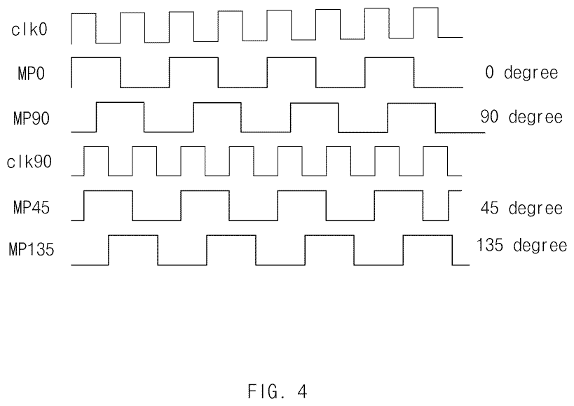

FIG. 4 is a timing diagram of division signals according to an embodiment of the present disclosure.

The division signal generator 300 of FIG. 3 according to an embodiment of the present disclosure is described with reference to FIG. 4.

Referring to FIG. 3, a division signal generator 300 includes a first latch 310, a second latch 320, a first inverter 330, a third latch 340, a fourth latch 350, and a second inverter 360. The division signal generator 300 may correspond to the division signal generator 210 of FIG. 2.

The first latch 310 receives a first clock signal CLK0 among a first clock signal CLK0 and a second clock signal CLK90 having a 90-degree phase difference with the first clock signal CLK0. The first latch 310 receives a reset signal RST and an inverted second division signal MP90 that is obtained when the second division signal MP90, an output signal of the second latch 320, is inverted by the first inverter 330 and outputs a first division signal MP0. For example, referring to FIG. 4, the first division signal MP0 is a signal having a frequency that is half the frequency of the first clock signal CLK0, although the present disclosure is not limited to this example.

The second latch 320 receives an inverted first clock signal CLK0, the reset signal RST, and the first division signal MP0 and outputs a second division signal MP90. For example, referring to FIG. 4, the second division signal MP90 is a signal having a 90-degree phase difference from the first division signal MP0.

The third latch 340 receives a second clock signal CLK90, the reset signal RST and an inverted fourth division signal MP135 that is obtained when the fourth division signal MP135, an output signal of the fourth latch 350, is inverted by the second inverter 360 and outputs a third division signal MP45. For example, referring to FIG. 4, the third division signal MP45 is a signal having a 45-degree phase difference from the first division signal MP0.

The fourth latch 350 may receive an inverted second clock signal CLK90, the reset signal RST, and the third division signal MP45 and outputs the fourth division signal MP135. For example, referring to FIG. 4, the fourth division signal MP135 is a signal having a 135-degree phase difference from the first division signal MP0.

Although not shown in FIG. 3, the first division signal MP0, the second division signal MP90, the third division signal MP45, and the fourth division signal MP135 generated by the division signal generator 300 are included in the division signals DS input to the pulse signal generator 230 of FIG. 2.

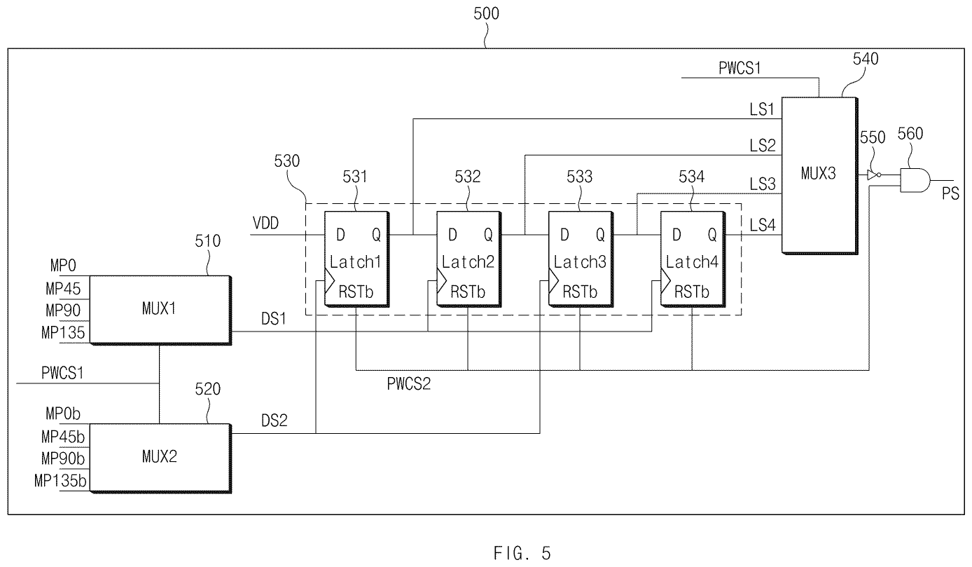

FIG. 5 is a circuit diagram illustrating a pulse signal generator 500 according to an embodiment of the present disclosure.

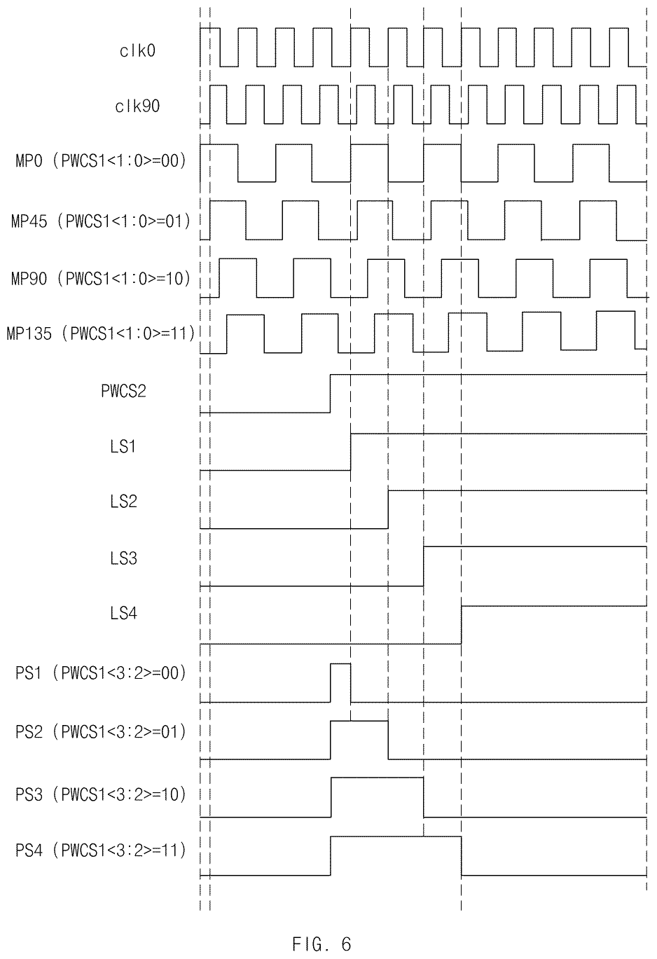

FIG. 6 is a timing diagram during operation of the image sensing device 200 according to an embodiment of the present disclosure.

The pulse signal generator 500 of FIG. 5 according to an embodiment of the present disclosure is described with reference to FIG. 6.

Referring to FIG. 5, the pulse signal generator 500 includes a first multiplexer MUX1 510, a second multiplexer MUX2 520, a shift register 530, a third multiplexer MUX3 540, an inverter 550, and an AND gate 560.

The pulse signal generator 500 selects a first division signal DS1 and a second division signal DS2 from among division signals MP0, MP45, MP90, MP135, MP0b, MP45b, MP90b, MP135b based on a first pulse width control signal PWCS1 among a plurality of pulse width control signals and generates pulse signals PS based on the first division signal DS1 and the second division signal DS2. For example, the pulse signal generator 500 generates latch signals LS1, LS2, LS3, LS4 using a shift register based on the first division signal DS1 and the second division signal DS2. The pulse signal generator 500 selects one of the latch signals LS1, LS2, LS3, LS4 in response to the first pulse width control signal PWCS1. The pulse signal generator 500 generates an inverted latch signal using the inverter 550 to invert the selected latch signal. The pulse signal generator 500 generates a pulse signal PS by performing a logical AND operation on the inverted latch signal and the second pulse width control signal PWCS2 among the pulse width control signals. The pulse width controller changes the first pulse width control signal PWCS1 among the pulse width control signals. The pulse signal generator 500 selects an updated latch signal among the latch signals LS1, LS2, LS3, LS4 according to the changed first pulse width control signal PWCS1, inverts the selected latch signal, and generates an updated inverted latch signal. The pulse signal generator 500 generates an updated pulse signal PS by performing a logical AND operation on the second pulse width control signal PWCS2 and the updated inverted latch signal.

For example, the first multiplexer MUX1 510 receives division signals MP0, MP45, MP90, MP135 and a first pulse width control signal PWCS1. Although not shown in the drawings, the first pulse width control signal PWCS1 is a signal transferred from the pulse width controller, for example, 220 in FIG. 2, to the pulse signal generator 500 as described. The first multiplexer MUX1 510 selects one of the division signals MP0, MP45, MP90, MP135 based on the first pulse width control signal PWCS1. For example, the first multiplexer MUX1 510 selects the division signal MP0 as the first division signal DS1 based on the first pulse width control signal PWCS1 and outputs the first division signal DS1 to the shift register 530. For example, the first multiplexer MUX1 510 selects one of the division signals MP0, MP45, MP90, MP135 based on the first and second bits of the first pulse width control signal PWCS1 and outputs the selected division signal to the shift register 530. According to an embodiment, referring to FIG. 6, when the first and second bits of the first pulse width control signal PWCS1 are 00, the first multiplexer MUX1 510 selects the division signal MP0 among the division signals MP0, MP45, MP90, MP135 as the first division signal DS1.

When the first and second bits of the first pulse width control signal PWCS1 are 01, the first multiplexer MUX1 510 selects the division signal MP45 among the division signals MP0, MP45, MP90, MP135 as the first division signal DS1. When the first and second bits of the first pulse width control signal PWCS1 are 10, the first multiplexer MUX1 510 selects the division signal MP90 among the division signals MP0, MP45, MP90, MP135 as the first division signal DS1. When the first and second bits of the first pulse width control signal PWCS1 are 11, the first multiplexer MUX1 510 selects the division signal MP135 among the division signals MP0, MP45, MP90, MP135 as the first division signal DS1.

The second multiplexer MUX2 520 receives inverted division signals MP0b, MP45b, MP90b, MP135b and a first pulse width control signal PWCS1. The second multiplexer MUX2 520 selects one of the inverted division signals MP0b, MP45b, MP90b, MP135b based on the first pulse width control signal PWCS1. For example, the second multiplexer MUX2 520 selects the inverted division signal MP0b as the second division signal DS2 based on the first pulse width control signal PWCS1 and outputs the second division signal DS2 to the shift register 530. For example, the second multiplexer MUX2 520 selects one of the inverted division signals MP0b, MP45b, MP90b, MP135b based on the first and second bits of the first pulse width control signal PWCS1 and outputs the selected inverted division signal to the shift register 530. According to an embodiment, referring to FIG. 6, when the first and second bits of the first pulse width control signal PWCS1 are 00, the second multiplexer MUX2 520 selects one inverted division signal MP0b from among the inverted division signals MP0b, MP45b, MP90b, MP135b as the second division signal DS2. When the first and second bits of the first pulse width control signal PWCS1 are 01, the second multiplexer MUX2 520 selects one inverted division signal MP45b from among the inverted division signals MP0b, MP45b, MP90b, MP135b as the second division signal DS2. When the first and second bits of the first pulse width control signal PWCS1 are 10, the second multiplexer MUX2 520 selects one inverted division signal MP90b from among the inverted division signals MP0b, MP45b, MP90b, MP135b as the second division signal DS2. When the first and second bits of the first pulse width control signal PWCS1 are 11, the second multiplexer MUX2 520 selects one inverted division signal MP135b from among the inverted division signals MP0b, MP45b, MP90b, MP135b as the second division signal DS2. The operation of the pulse signal generator 500 is not limited to this example.

The shift register 530 includes a first latch 531, a second latch 532, a third latch 533, and a fourth latch 534. The first latch 531 generates a first latch signal LS1 by latching a signal corresponding to a power-supply voltage VDD. For example, the first latch 531 generates the first latch signal LS1 by latching a signal corresponding to the VDD voltage based on the second division signal DS2 and the second pulse width control signal PWCS2. For example, when the first and second bits of the first pulse width control signal PWCS1 are 00, and the waveform of the second pulse width control signal PWCS2 is as shown in FIG. 6, a waveform of the first latch signal LS1 is shown as the waveform LS1 in FIG. 6.

The second latch 532 generates a second latch signal LS2 by latching the first latch signal LS1. For example, the second latch 532 generates the second latch signal LS2 by latching the first latch signal LS1 based on the first division signal DS1 and the second pulse width control signal PWCS2. For example, when the first and second bits of the first pulse width control signal PWCS1 are 00, and the waveform of the second pulse width control signal PWCS2 is as shown in FIG. 6, the waveform of the second latch signal LS2 is shown as the waveform LS2 in FIG. 6.

The third latch 533 generates a third latch signal LS3 by latching the second latch signal LS2. For example, the third latch 533 generates the third latch signal LS3 by latching the second latch signal LS2 based on the second division signal DS2 and the second pulse width control signal PWCS2. For example, when the first and second bits of the first pulse width control signal PWCS1 are 00, and the waveform of the second pulse width control signal PWCS2 is as shown in FIG. 6, the waveform of the third latch signal LS3 is shown as the waveform LS3 of FIG. 6.

The fourth latch 534 generates a fourth latch signal LS4 by latching the third latch signal LS3. For example, the fourth latch 534 generates the fourth latch signal LS4 by latching the third latch signal LS3 based on the first division signal DS1 and the second pulse width control signal PWCS2. For example, when the first and second bits of the first pulse width control signal PWCS1 are 00, and the waveform of the second pulse width control signal PWCS2 is as shown in FIG. 6, the waveform of the fourth latch signal LS4 is shown as the waveform LS4 in FIG. 6.

The third multiplexer MUX3 540 selects one of the first latch signal LS1 to the fourth latch signal LS4 based on the first pulse width control signal PWCS1 and outputs the latch signal. For example, when the third and fourth bits of the first pulse width control signal PWCS1 are 00, the third multiplexer MUX3 540 selects the first latch signal LS1 among the latch signals LS1 to LS4 and outputs the selected first latch signal LS1. When the third and fourth bits of the first pulse width control signal PWCS1 are 01, the third multiplexer MUX3 540 selects the second latch signal LS2 among the latch signals LS1 to LS4 and outputs the selected second latch signal LS2. When the third and fourth bits of the first pulse width control signal PWCS1 are 10, the third multiplexer MUX3 540 selects the third latch signal LS3 among the latch signals LS1 to LS4 and outputs the selected third latch signal LS3. When the third and fourth bits of the first pulse width control signal PWCS1 are 11, the third multiplexer MUX3 540 selects the fourth latch signal LS4 among the latch signals LS1 to LS4 and outputs the selected fourth latch signal LS4. The operation of the pulse signal generator 500 is not limited to this example.

The inverter 550 inverts the latch signal selected by the third multiplexer MUX3 540.

The AND gate 560 may output a pulse signal PS by performing a logical AND operation between the inverted latch signal and the second pulse width control signal PWCS2. For example, when the first to fourth bits of the first pulse width control signal are 0000, the first multiplexer MUX1 510 selects the division signal MP0 as the first division signal DS1, the second multiplexer MUX2 520 selects the division signal MP0b as the second division signal DS2, and the third multiplexer MUX3 540 selects the first latch signal LS1. As a result, the AND gate 560 outputs a first pulse signal PS1 as shown in FIG. 6. When the clock signals clk0, clk90 shown in FIG. 6 have a frequency of 1 GHZ and the division signals MP0, MP45, MP90, MP135 have a frequency of 500 MHz, the pulse width of the first pulse signal PS1 is 500 ps. When the first to fourth bits of the first pulse width control signal are 0001, the first multiplexer MUX 510 selects the division signal MP0 as the first division signal DS1, the second multiplexer MUX2 520 selects the division signal MP0b as the second division signal DS2, and the third multiplexer MUX3 540 selects the second latch signal LS2. As a result, the AND gate 560 outputs a second pulse signal PS2 as shown in FIG. 6. When the clock signals clk0, clk90 shown in FIG. 6 have a frequency of 1 GHz and the division signals MP0, MP45, MP90, MP135 have a frequency of 500 MHz, the pulse width of the second pulse signal PS2 is 1.5 ns. When the first to fourth bits of the first pulse width control signal are 0010, the first multiplexer MUX1 510 selects the division signal MP0 as the first division signal DS1, the second multiplexer MUX2 520 selects the division signal MP0b as the second division signal DS2, and the third multiplexer MUX3 540 selects the third latch signal LS3. As a result, the AND gate 560 outputs a third pulse signal PS3 as shown in FIG. 6. When the clock signals clk0, clk90 shown in FIG. 6 have a frequency of 1 GHz and the division signals MP0, MP45, MP90, MP135 have a frequency of 500 MHz, the pulse width of the third pulse signal PS3 is 2.5 ns. When the first to fourth bits of the first pulse width control signal are 0011, the first multiplexer MUX1 510 selects the division signal MP0 as the first division signal DS1, the second multiplexer MUX2 520 selects the division signal MP0b as the second division signal DS2, and the third multiplexer MUX3 540 selects the fourth latch signal LS4. As a result, the AND gate 560 outputs a fourth pulse signal PS4 as shown in FIG. 6. When the clock signals clk0, clk90 shown in FIG. 6 have a frequency of 1 GHz and the division signals MP0, MP45, MP90, MP135 have a frequency of 500 MHz, the pulse width of the fourth pulse signal PS4 is 3.5 ns. The operation of the pulse signal generator 500 is not limited to this example.

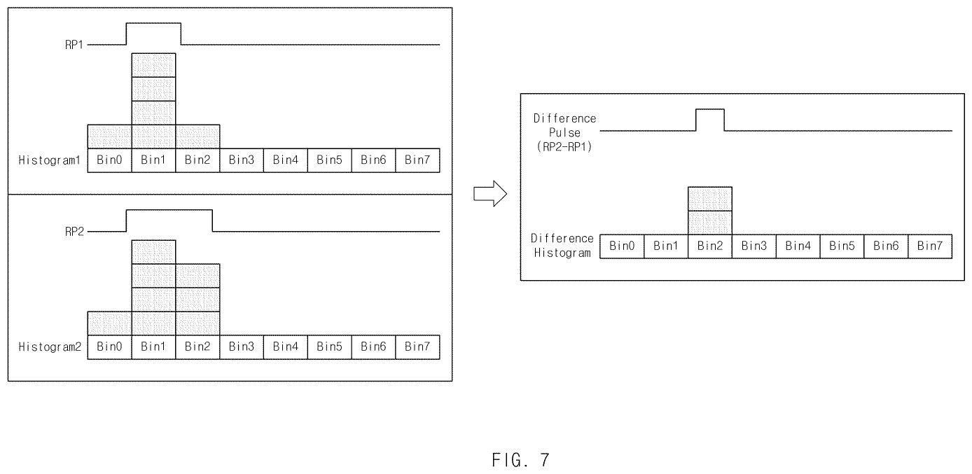

FIG. 7 includes histograms generated during a method of operating the image sensing device according to an embodiment of the present disclosure.

According to an embodiment of the present disclosure, a method of operating the image sensing device shown in FIG. 5 is described with reference to FIG. 6.

The image sensing device, according to an embodiment of the present disclosure, transmits laser pulses having different pulse widths to a target object. For example, the image sensing device generates a first pulse signal having a first pulse width and a second pulse signal having a second pulse width based on division signals and pulse width control signals, transmits a first laser pulse to the object based on the first pulse signal, and transmits a second laser pulse to the object based on the second pulse signal. When the second pulse width is longer than the first pulse width, the pulse width of the second laser pulse is greater than the pulse width of the first laser pulse, although the present disclosure is not limited to this example.

Referring to FIG. 7, when the pulse width of the first laser pulse is shorter than the pulse width of the second laser pulse, and the image sensing device transmits the first and second laser pulses to an object, the image sensing device receives a first reflected pulse RP1 generated by reflection of the first laser pulse from the object and a second reflected pulse RP2 generated by reflection of the second laser pulse from the object. The image sensing device generates image data using a readout circuit or the like upon receiving pixel data corresponding to the reflected pulses RP1, RP2 received through the pixel array. For example, the image sensing device generates the first image data based on the first reflected pulse and generates the second image data based on the second reflected pulse.

As shown in FIG. 7, the image sensing device generates a first histogram based on the first image data corresponding to the first reflected pulse RP1 and generates a second histogram based on the second image data corresponding to the second reflected pulse RP2. At this time, the image sensing device generates the histograms using a time-to-digital converter TDC or the like. Because the pulse width of the first laser pulse is smaller than the pulse width of the second laser pulse, the pulse width of the first reflected pulse is smaller than the pulse width of the second reflected pulse. The image sensing device calculates a difference between the first histogram and the second histogram and generates a difference histogram for a difference pulse, RP2−RP1, which is a difference between the first reflected pulse and the second reflected pulse. The pulse width of the difference pulse is smaller than the pulse widths of the first and second reflected pulses. For example, the pulse width of the difference pulse may be narrower than a minimum pulse width of the laser pulses the image sensing device is able to generate. Therefore, because the image sensing device generates the difference pulse and the difference histogram, the image sensing device obtains distance information using a difference histogram for a pulse width smaller than the pulse widths of transmittable laser pulses, resulting in an increase in depth resolution. For example, the image sensing device may generate accurate distance information by generating distance information using time information corresponding to a peak count value of the difference histogram. For example, as shown in FIG. 7, distance information is generated using time information corresponding to a second bin bin2 corresponding to the peak count value.

The image sensing device generates laser pulses having different pulse widths by adaptively generating pulse signals having different pulse widths. For example, referring to FIG. 7, the image sensing device generates a first pulse signal PS1 and a second pulse signal PS2 by selecting the first latch signal LS1 and the second latch signal LS2 among latch signals LS1, LS2, LS3, LS4. The image sensing device calculates a difference pulse having a pulse width corresponding to a difference between the first pulse width of the first pulse signal PS1 and the second pulse width of the second pulse signal PS2. Alternatively, the image sensing device may generate a second pulse signal PS2 and a third pulse signal PS3 by selecting the second latch signal LS2 and the third latch signal LS3 among the latch signals LS1, LS2, LS3, LS4. The image sensing device may calculate a difference pulse having a pulse width corresponding to a difference between the second pulse width of the second pulse signal PS2 and the third pulse width of the third pulse signal PS3. Thus, the image sensing device generates pulse signals by adaptively selecting various combinations of latch signals, such that the image sensing device generates pulse signals and calculates difference pulses.

The image sensing device generates accurate distance information by selecting some of the latch signals LS1, LS2, LS3, LS4 based on the generated distance information. For example, the image sensing device generates a first pulse signal PS1 and a second pulse signal PS2 by selecting the first latch signal LS1 and the second latch signal LS2 among the latch signals LS1, LS2, LS3, LS4 and generates information of the distance to the target object by transmitting a first laser pulse and a second laser pulse. When the image sensing device determines that the target object is located farther than a threshold distance based on the distance information, the image sensing device generates a third pulse signal PS3 and a fourth pulse signal PS4 having pulse widths larger than the pulse widths of the first pulse signals PS1 and the second pulse signal PS2, thereby transmitting laser pulses having larger pulse widths to the target object located farther than the threshold distance. Because reflected pulses generated by a distant object may suffer energy loss while traveling to the image sensing device, the image sensing device may reduce the influence of energy loss of the reflected pulses by transmitting laser pulses having larger pulse widths than the pulse widths of laser pulses transmitted to a nearby object. Thus, the image sensing device may generate accurate distance information by adaptively controlling the pulse widths of the transmitted Tx laser pulses.

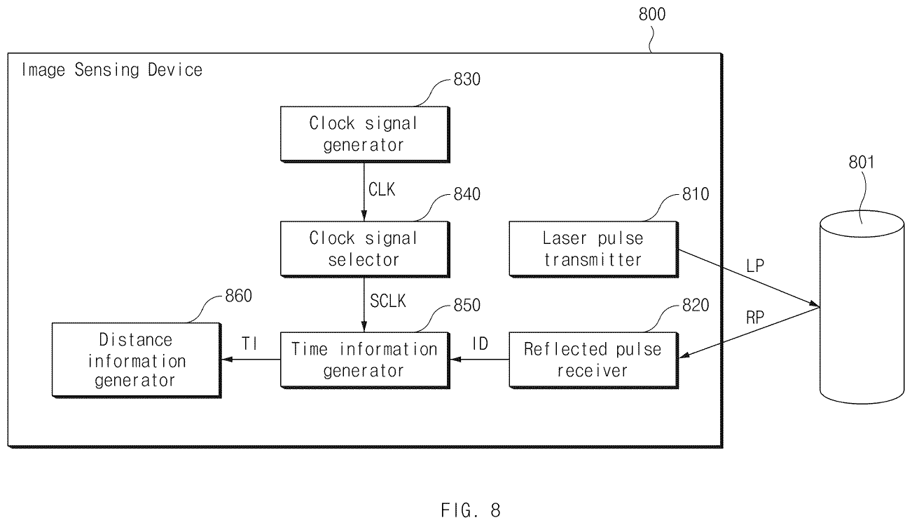

FIG. 8 is a block diagram illustrating the image sensing device according to an embodiment of the present disclosure.

Referring to FIG. 8, the image sensing device 800 according to an embodiment of the present disclosure includes a laser pulse transmitter 810, a reflected pulse receiver 820, a clock signal generator 830, a clock signal selector 840, a time information generator 850, and a distance information generator 860.

The laser pulse transmitter 810 transmits laser pulses LP to a target object 801 to generate distance information. The transmitted Tx laser pulses LP are reflected by the target object 801 and become reflected pulses RP. The laser pulse transmitter 810 may correspond to the light source 10 and the light source driver 30 shown in FIG. 1.

The reflected pulse receiver 820 receives reflected pulses RP reflected by the target object 801. The reflected pulse receiver 820 generates image data ID based on the received reflected pulses RP. The reflected pulse receiver 820 may correspond to the pixel array 110 and the readout circuit 130 shown in FIG. 1.

The clock signal generator 830 generates clock signals CLK having different phases. For example, the clock signal generator 830 generates clock signals having phase differences of 22.5 degrees, 45 degrees, 67.5 degrees, 90 degrees, 112.5 degrees, 135 degrees, and 157.5 degrees with respect to a reference clock signal, although the present disclosure is not limited to these examples. For example, the clock signal generator 830 may be a voltage-controlled oscillator VCO.

The clock signal selector 840 selects one of the clock signals and outputs the selected clock signal SCLK. For example, the clock signal selector 840 selects a first clock signal and a second clock signal among the clock signals and sequentially outputs the selected first and second clock signals. The clock signal selector 840 may be a multiplexer MUX, although the present disclosure is not limited to this example.

The time information generator 850 generates time information TI regarding the time elapsed from a first point in time until a reflected pulse is received based on clock signals. For example, the time information generator 850 generates time information TI regarding the time elapsed from the first point in time until the reflected pulse is received based on clock signals and image data of the reflected pulses received by the reflected pulse receiver 820. For example, the time information generator 850 generate first time information indicating the time elapsed from a first point in time until the reflected pulse is received based on a first clock signal and generates second time information indicating the time elapsed from a second point in time, which is subsequent to the first point in time, until the reflected pulse is received based on a second clock signal. The time information generator 850 may generate time information using two clock signals at one time.

For example, the time information generator 850 generates first time information indicating the time elapsed from the first point in time, at which time light is transmitted, until the reflected pulse is received based on the first clock signal and a third clock signal. The time information generator 850 may be a time-to-digital converter TDC, although the present disclosure is not limited to this example.

The distance information generator 860 generates histograms based on time information TI. The distance information generator 860 generates distance information for an object based on the histograms. For example, the distance information generator 860 generates preliminary histograms using time information based on different clock signals and generates a combined histogram by summing the preliminary histograms. The distance information generator 860 generates distance information using time information corresponding to a peak count value of the combined histogram. Because the Y-axis of the histogram corresponds to the count value of laser pulses, the distance information generator 860 calculates a distance to the object using the speed of light and the time information corresponding to the bin number having the peak count value.

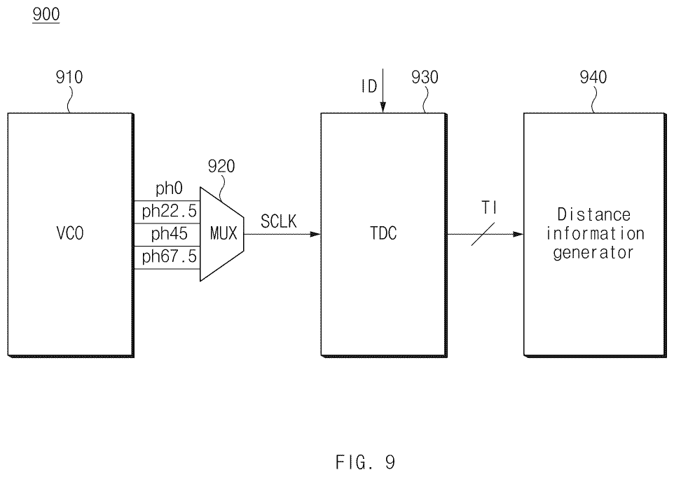

FIG. 9 is a block diagram illustrating an image sensing device according to an embodiment of the present disclosure.

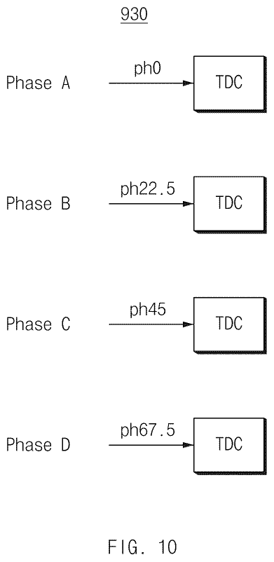

FIG. 10 is a diagram illustrating a time-to-digital converter of the image sensing device according to an embodiment of the present disclosure.

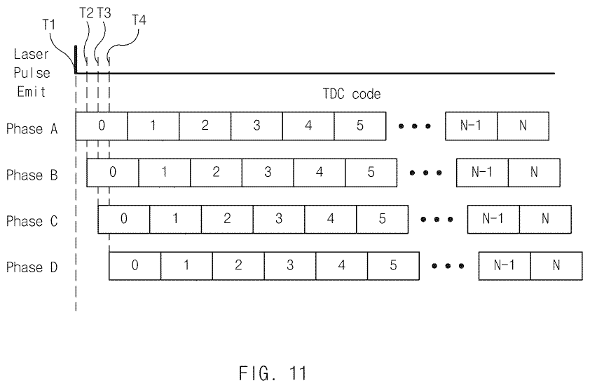

FIG. 11 is a timing diagram during a method of operating the image sensing device according to an embodiment of the present disclosure.

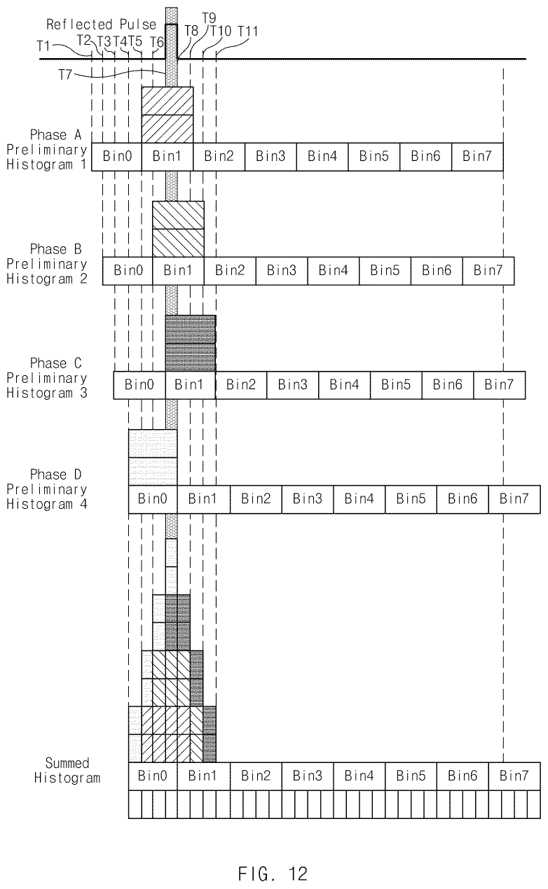

FIG. 12 is a timing diagram including histograms generated during a method of operating the image sensing device according to an embodiment of the present disclosure.

The image sensing device of FIG. 9 according to an embodiment of the present disclosure is described with reference to FIG. 8, FIG. 10, FIG. 11, and FIG. 12.

Referring to FIG. 9, the image sensing device 900 includes a voltage-controlled oscillator VCO 910, a multiplexer MUX 920, a time-to-digital converter TDC 930, and a distance information generator 940. The VCO 910 may correspond to the clock signal generator 830 of FIG. 8, the MUX 920 may correspond to the clock signal selector 840 of FIG. 8, and the TDC 930 may correspond to the time information generator 850 of FIG. 8.

The VCO 910 generates four clock signals ph0, ph22.5, ph45, ph67.5 having different phases. The clock signal ph0 and the clock signal ph22.5 have a phase difference of 22.5 degrees, the clock signal ph0 and the clock signal ph45 have a phase difference of 45 degrees, and the clock signal ph0 and the clock signal ph67.5 have a phase difference of 67.5 degrees.

The multiplexer MUX 920 sequentially selects and output each of the clock signals ph0, ph22.5, ph45, ph67.5. For example, referring to FIG. 10, in phase A, the MUX 920 selects the clock signal ph0 and outputs the selected clock signal ph0 to the TDC 930. In phase B, the MUX 920 selects the clock signal ph22.5 and outputs the selected clock signal ph22.5 to the TDC 930. In phase C, the MUX 920 selects the clock signal ph45, and outputs the selected clock signal ph45 to the TDC 930. In phase D, the MUX 920 selects the clock signal ph67.5, and outputs the selected clock signal ph67.5 to the TDC 930.

The TDC 930 generates time information TI based on the selected clock signal SCLK and image data ID. Although not shown in FIG. 9, the image data ID is transferred from the reflected pulse receiver to the TDC 930. The image data ID includes information about the received reflected pulse, such as a time at which the reflected pulse is received. The time information TI includes information about the time elapsed from a transmission time to the reception time of the reflected pulse.

The TDC 930 generates first time information indicating the time elapsed from a first time to the reception time of the reflected pulse based on a first clock signal and generates second time information indicating the time elapsed from a second time subsequent to the first time to the reception time of the reflected pulse based on a second clock signal.

For example, referring to FIG. 11, when a laser pulse is transmitted at a first time T1, the TDC 930 generates first time information that indicates the time elapsed from the first time T1 to the reception time of the reflected pulse based on the clock signal ph0 in Phase A; generates second time information that indicates the time elapsed from the second time T2 to the reception time of the reflected pulse, based on the clock signal ph22.5 in Phase B; generates third time information that indicates the time elapsed from the third time T3 to the reception time of the reflected pulse, based on the clock signal ph45 in Phase C; and generates fourth time information that indicates the time elapsed from the fourth time T5 to the reception time of the reflected pulse, based on the clock signal ph67.5 in Phase D. FIG. 11 illustrates TDC codes for each phase, and the TDC codes correspond to bin numbers of a histogram.

The distance information generator 940 generates preliminary histograms based on time information. For example, referring to FIG. 12, the distance information generator 940 generates a first preliminary histogram based on first time information in Phase A. For example, the first preliminary histogram is a histogram including a first time T1 as a start point. Because a reflected pulse is received between a seventh time T7 and an eighth time T8, the first preliminary histogram is a histogram with a count value accumulated in a first bin including the seventh time T7 to the eighth time T8. The distance information generator 940 generates a second preliminary histogram based on second time information in Phase B. For example, the second preliminary histogram is a histogram including a second time T2 as a start point. When a reflected pulse is received between the seventh time T7 and the eighth time T8, the second preliminary histogram is a histogram with a count value accumulated in a first bin including the seventh time T7 to the eighth time T8. The distance information generator 940 generates a third preliminary histogram based on third time information in Phase C. For example, the third preliminary histogram is a histogram including a third time T3 as a start point. When a reflected pulse is received between the seventh time T7 and the eighth time T8, the first preliminary histogram is a histogram with a count value accumulated in a first bin including the seventh time T7 to the eighth time T8. The distance information generator 940 generates a fourth preliminary histogram based on fourth time information in Phase D. Specifically, the fourth preliminary histogram may be a histogram including a fourth time T4 as a start point. When a reflected pulse is received between the seventh time T7 and the eighth time T8, the fourth preliminary histogram is a histogram with a count value accumulated in a zero-th bin including the seventh time T7 to the eighth time T8. A time difference between adjacent times, such as a time difference between the first time T1 and the second time T2, may be less than a time interval corresponding to the width of a bin.

The distance information generator 940 generates a combined or summation histogram by summing or adding count values of preliminary histograms based on time information. The combined histogram may be generated by combining count values other than by summing, for example, including multiplication, division, subtraction, weighting, other functions, and combinations of functions. For example, referring to FIG. 12, the distance information generator 940 generates the summation histogram by summing count values of the first preliminary histogram, count values of a second preliminary histogram, count values of the third preliminary histogram, and count values of the fourth preliminary histogram that include different start points aligned by time. For example, when the fourth time point T4 is a start point of the combined or summation histogram, the count value of the first preliminary histogram is referred as a first count value, the count value of the second preliminary histogram is referred to as a second count value, the count value of the third preliminary histogram is referred to as a third count value, the count value of the fourth preliminary histogram is referred to as a fourth count value, and the count value of the combined or summation histogram is referred to as a combined count value, because the fourth count value is accumulated only in the zero-th bin of the fourth preliminary histogram during a time interval between the fourth time T4 and the fifth time T5, the combined count value of the combined or summation histogram between the fourth time T4 and the fifth time T5 is equal to the fourth count value. Because the first count value of the first preliminary histogram and the fourth count value of the fourth preliminary histogram are accumulated during a time interval between the fifth time T5 and the sixth time T6, the combined count value of the combined or summation histogram between the fifth time T5 and the sixth time T6 is equal to the sum of the first count value and the fourth count value. Because the first count value of the first preliminary histogram, the second count value of the second preliminary histogram, and the fourth count value of the fourth preliminary histogram are accumulated during a time interval between the sixth time T6 and the seventh time T7, the combined count value of the combined or summation histogram between the sixth time T6 and the seventh time T7 is equal to the sum of the first count value, the second count value, and the fourth count value. Because the first count value of the first preliminary histogram, the second count value of the second preliminary histogram, the third count value of the third preliminary histogram, and the fourth count value of the fourth preliminary histogram are accumulated during a time interval between the seventh time T7 and the eighth time T8, the combined count value of the combined or summation histogram between the seventh time T7 and the eighth time T8 is equal to the sum of the first count value, the second count value, the third count value, and the fourth count value. Because the first count value of the first preliminary histogram, the second count value of the second preliminary histogram, and the third count value of the third preliminary histogram are accumulated during a time interval between the eighth time T8 and the ninth time T9, the combined count value of the combined or summation histogram between the eighth time T8 and the ninth time T9 is equal to the sum of the first count value, the second count value, and the third count value. Because the second count value of the second preliminary histogram and the third count value of the third preliminary histogram are accumulated during a time interval between the ninth time T9 and the tenth time T10, the combined count value of the combined or summation histogram between the ninth time T9 and the tenth time T10 is equal to the sum of the second count value and the third count value. Because only the third count value is accumulated during the first bin of the third preliminary histogram in a time interval between the tenth time T10 and the eleventh time T11, the combined count value of the combined or summation histogram between the tenth time T10 and the eleventh time T11 is equal to the third count value.

The distance information generator 940 generates distance information for an object using the combined or summation histogram. For example, the distance information generator 940 calculates a distance to the object using the speed of light and time information corresponding to a bin including a peak count value. For example, the combined or summation histogram of FIG. 12 includes the peak count value during a time interval between a seventh time T7 and an eighth time T8 of the zero-th bin. Therefore, the distance information generator 940 calculates the distance to the object by multiplying the speed of light by the time interval between to the seventh time T7 and the eighth time T8. Because the distance information generator 940 generates distance information using time information corresponding to the seventh time T7 to the eighth time T8, the resolution of the bins of the combined or summation histogram is considered as four times higher resolution than the resolution of the bins of the preliminary histograms. Thus, the width of the bins of the combined or summation histogram are one-fourth or 0.25 times the width of the bins of the preliminary histograms. Therefore, the image sensing device 900 generates preliminary histograms including different start points based on clock signals having a phase difference, generates a combined or summation histogram by summing the preliminary histograms, and improves the resolution of the bins. Accordingly, the image sensing device 900 may generate accurate distance information using the combined or summation histogram.

The image sensing device 900 determines the quantity of laser pulses used to generate each preliminary histogram. For example, when the quantity of laser pulses to be transmitted to an object to generate distance information about the object is preset, the image sensing device 900 divides the preset quantity of laser pulses by the quantity of preliminary histograms, transmits a quantity of laser pulses as the divided number of laser pulses, and generates the preliminary histograms.

For example, when the image sensing device 900 is configured to transmit 1000 laser pulses to measure the distance to an object and generates four preliminary histograms as shown in FIG. 12, the image sensing device 900 transmits 250 laser pulses to generate the first preliminary histogram, transmits 250 laser pulses to generate the second preliminary histogram, transmits 250 laser pulses to generate the third preliminary histogram, and transmits 250 laser pulses to generate the fourth preliminary histogram.

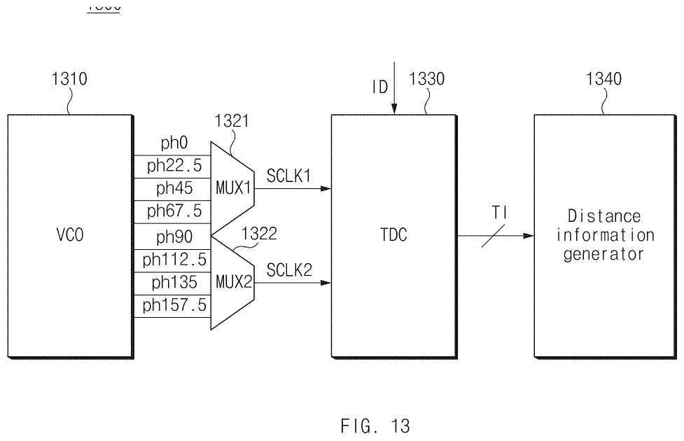

FIG. 13 is a block diagram illustrating an image sensing device according to an embodiment of the present disclosure.

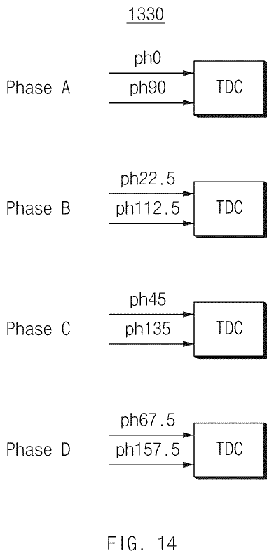

FIG. 14 is a diagram illustrating a time-to-digital converter of the image sensing device according to an embodiment of the present disclosure.

The image sensing device of FIG. 13, according to an embodiment of the present disclosure, is described with reference to FIG. 11 and FIG. 14.

Referring to FIG. 13, the image sensing device 1300 includes a voltage-controlled oscillator VCO 1310, a first multiplexer MUX1 1321, a second multiplexer MUX2 1322, a time-to-digital converter TDC 1330, and a distance information generator 1340. The VCO 1310 may correspond to the clock signal generator 830 of FIG. 8, the multiplexers 1321, 1322 may correspond to the clock signal selector 840 of FIG. 8, and the TDC 1330 may correspond to the time information generator 850 of FIG. 8.

The VCO 1310 generates eight clock signals ph0, ph22.5, ph45, ph67.5, ph90, ph112.5, ph135, ph157.5 having different phases. The clock signal ph0 has a phase difference of 22.5 degrees with the clock signal ph22.5. The clock signal ph0 has a phase difference of 45 degrees with the clock signal ph45. The clock signal ph0 has a phase difference of 67.5 degrees with the clock signal ph67.5. The clock signal ph0 has a phase difference of 90 degrees with the clock signal ph90. The clock signal ph0 has a phase difference of 112.5 degrees with the clock signal ph112.5. The clock signal ph0 has a phase difference of 135 degrees with the clock signal ph135. The clock signal ph0 has a phase difference of 157.5 degrees with the clock signal ph157.5.

Each of the first multiplexer MUX1 1321 and the second multiplexer MUX2 1322 selects and outputs clock signals. For example, referring to FIG. 14, during Phase A, the first MUX 1321 selects the clock signal ph0 and outputs the selected clock signal ph0 to the TDC 1330, and the second MUX 1322 selects the clock signal ph90 and outputs the selected clock signal ph90 to the TDC 1330. During Phase B, the first MUX 1321 selects the clock signal ph22.5 and outputs the selected clock signal ph22.5 to the TDC 1330, and the second MUX 1322 selects the clock signal ph112.5 and outputs the selected clock signal clock signal ph112.5 to the TDC 1330. During Phase C, the first MUX 1321 selects the clock signal ph45 and outputs the selected clock signal ph45 to the TDC 1330, and the second MUX 1322 selects the clock signal ph135 and outputs the selected clock signal 135 to the TDC 1330. During Phase D, the first MUX 1321 selects the clock signal ph67.5 and outputs the selected clock signal ph67.5 to the TDC 1330, and the second MUX 1322 selects the clock signal ph157.5 and outputs the clock signal ph157.5 to the TDC 1330.

The TDC 930 may generate time information TI based on a first clock signal SCLK1 selected by the first MUX 1321, a second clock signal SCLK2 selected by the second MUX 1322, and image data ID. Although not shown in FIG. 13, the image data ID is transferred from the reflected pulse receiver to the TDC 1330. The image data ID includes information about the received reflected pulse, such as a time at which the reflected pulse is received. The time information TI includes information about the time elapsed from a time of transmission of light to the reception time of the reflected pulse.

The TDC 1330 generates first time information indicating the time elapsed from a first or transmission time to the reception time of the reflected pulse based on the first clock signal SCLK1 selected by the first MUX 1321 and the second clock signal SCLK2 selected by the second multiplexer MUX2 1322 and generates second time information indicating the time elapsed from a second time, which is subsequent to the first time, to the reception time of the reflected pulse based on a second clock signal.

For example, referring to FIG. 11, when a laser pulse is transmitted at first time T1, the TDC 1330 generates first time information indicating the time elapsed from the first time T1 to the reception time of the reflected pulse based on the clock signal ph0 and the clock signal ph90 in Phase A, generates second time information indicating the time elapsed from the second time T2 to the reception time of the reflected pulse based on the clock signal ph22.5 and the clock signal ph112.5 in Phase B, generates third time information indicating the time elapsed from the third time T3 to the reception time of the reflected pulse based on the clock signal ph45 and the clock signal ph135 in Phase C, and generates fourth time information indicating the time elapsed from the fourth time T4 to the reception time of the reflected pulse based on the clock signal ph67.5 and the clock signal ph157.5 in Phase D.

The distance information generator 1340 generates preliminary histograms based on time information. The distance information generator 1340 may correspond to the distance information generator 940 of FIG. 9.

The image sensing device according to an embodiment of the present disclosure controls a pulse width of a transmitted Tx laser pulse.

The image sensing device according to an embodiment of the present disclosure acquires accurate distance information by generating a histogram corresponding to a difference in reflected pulses, for example, a time difference between reflected pulses reflected from a target object.

The image sensing device according to an embodiment of the present disclosure generates histograms using clock signals having a phase difference.

The image sensing device, according to an embodiment of the present disclosure, acquires accurate distance information by generating a combined histogram using summation of histograms.

In an embodiment, the pulse signal generator selects a first division signal and a second division signal among the division signals based on a first pulse width control signal among the pulse width control signals and generates the first pulse signal and the second pulse signal based on the first division signal and the second division signal.

In an embodiment, the pulse signal generator generates latch signals using a shift register based on the first division signal and the second division signal.

In an embodiment, the pulse signal generator generates a first inverted latch signal by selecting a first latch signal among a plurality of latch signals according to the first pulse width control signal and inverting the first latch signal.

In an embodiment, the pulse signal generator generates the first pulse signal by performing a logical AND operation on the first inverted latch signal and a second pulse width control signal among a plurality of pulse width control signals.

In an embodiment, the pulse width controller changes the first pulse width control signal among a plurality of pulse width control signals. The pulse signal generator selects a second latch signal among the plurality of latch signals according to the changed first pulse width control signal and inverts the second latch signal to generate a second inverted latch signal.

In an embodiment, the pulse signal generator generates the second pulse signal by performing a logical AND operation on a second pulse width control signal and the second inverted latch signal.

In an embodiment, the pulse width controller changes the first pulse width control signal based on the distance information such that the first latch signal is selected, which first latch signal has a larger phase difference with respect to a second pulse width control signal as a distance to the object increases.

In an embodiment, the pulse width controller generates the pulse width control signals that control the pulse signal generator based on the distance information such that each of the first pulse width and the second pulse width increases proportionally with a distance to the object.

In an embodiment, the distance information generator calculates a difference between the first histogram and the second histogram, generates a difference histogram for a difference pulse that is a difference between the first reflected pulse and the second reflected pulse, and generates the distance information using time information corresponding to a peak count value of the difference histogram.

In an embodiment, the distance information generator generates a first preliminary histogram including the first time as a start point based on the first time information and generates a second preliminary histogram including the second time as a start point based on the second time information.

In an embodiment, the distance information generator generates a combined or summation histogram by summing the first preliminary histogram and the second preliminary histogram and generates the distance information based on the combined or summation histogram.

In an embodiment, the distance information generator generates the distance information using third time information corresponding to a bin including a peak count value of the combined or summation histogram.

In an embodiment, the image sensing device includes a second clock signal selector configured to select a third clock signal among the plurality of clock signals, wherein the time information generator generates the first time information indicating a time elapsed from the first time to a reception time of the reflected pulse based on the first clock signal and the third clock signal.

In an embodiment, the first clock signal has a phase difference of 90 degrees with the third clock signal.

In an embodiment, the AND gate outputs a first pulse signal and a second pulse signal. The laser pulse transmitter transmits a first laser pulse based on the first pulse signal and transmits a second laser pulse based on the second pulse signal. The reflected pulse receiver receives a first reflected pulse generated when the first laser pulse is reflected from the object and a second reflected pulse generated when the second laser pulse is reflected from the object and generates first image data and second image data based on the first reflected pulse and the second reflected pulse, respectively. The image sensing device includes a distance information generator configured to generate a first histogram based on the first image data, generate a second histogram based on the second image data, and generate distance information for the object based on a difference between the first histogram and the second histogram.

In an embodiment, the pulse width controller changes the first pulse width control signal based on the distance information such that each of a first pulse width of the first pulse signal and a second pulse width of the second pulse signal increases proportionally with distance to the object.

In an embodiment, the distance information generator calculates a difference between the first histogram and the second histogram, generates a difference histogram for a difference pulse that is a difference between the first reflected pulse and the second reflected pulse, and generates the distance information using time information corresponding to a peak count value of the difference histogram.

The present disclosure may provide a variety of effects directly or indirectly described by the present disclosure.

Concepts are disclosed in conjunction with examples and embodiments. Those skilled in the art will understand that various modifications, additions, combinations, and substitutions are possible without departing from the scope and technical concepts of the present disclosure. The embodiments disclosed in the present specification should be considered from an illustrative standpoint and not a restrictive standpoint. Therefore, the scope of the present disclosure is not limited to these descriptions. All changes within the meaning and range of equivalency of the claims are included within their scope.

What is claimed is:

1. An image sensing device comprising:
a pulse signal generator configured to generate a first pulse signal having a first pulse width and a second pulse signal having a second pulse width;
a laser pulse transmitter configured to transmit a first laser pulse based on the first pulse signal and transmit a second laser pulse based on the second pulse signal;
a reflected pulse receiver configured to receive a first reflected pulse generated when the first laser pulse is reflected from an object and a second reflected pulse generated when the second laser pulse is reflected from the object and generate first image data and second image data based on the first reflected pulse and the second reflected pulse, respectively; and
a distance information generator configured to generate a first histogram based on the first image data, generate a second histogram based on the second image data, and generate distance information for the object based on a difference between the first histogram and the second histogram.

2. The image sensing device according to claim 1, further comprising a division signal generator configured to generate a plurality of division signals by dividing a plurality of clock signals;
wherein the pulse signal generator is configured to:
select a first division signal and a second division signal among the plurality of division signals based on a first pulse width control signal among a plurality of pulse width control signals; and
generate the first pulse signal and the second pulse signal based on the first division signal and the second division signal.

3. The image sensing device according to claim 2, wherein the pulse signal generator is configured to generate a plurality of latch signals based on the first division signal and the second division signal and using a shift register.

4. The image sensing device according to claim 3, wherein the pulse signal generator is configured to generate a first inverted latch signal by selecting a first latch signal among the plurality of latch signals according to the first pulse width control signal and inverting the first latch signal.

5. The image sensing device according to claim 4, wherein the pulse signal generator is configured to generate the first pulse signal by performing a logical AND operation on the first inverted latch signal and a second pulse width control signal among the plurality of pulse width control signals.

6. The image sensing device according to claim 4, further comprising a pulse width controller configured to:
generate a plurality of pulse width control signals;
change the first pulse width control signal among the plurality of pulse width control signals; and
wherein the pulse signal generator is configured to select a second latch signal among the latch signals according to the changed first pulse width control signal and invert the second latch signal to generate a second inverted latch signal.

7. The image sensing device according to claim 6, wherein the pulse signal generator is configured to generate the second pulse signal by performing a logical AND operation on a second pulse width control signal and the second inverted latch signal.

8. The image sensing device according to claim 6, wherein the pulse width controller is configured to change the first pulse width control signal based on the distance information such that the first latch signal is selected, which first latch signal has a larger phase difference with respect to a second pulse width control signal as a distance to the object increases.

9. The image sensing device according to claim 1, wherein the pulse width controller is configured to generate a plurality of pulse width control signals that control the pulse signal generator based on the distance information such that each of the first pulse width and the second pulse width increases proportionally with a distance to the object.

10. The image sensing device according to claim 1, wherein the distance information generator is configured to:
calculate a difference between the first histogram and the second histogram;
generate a difference histogram for a difference pulse, which is a difference between the first reflected pulse and the second reflected pulse; and
generate the distance information using time information corresponding to a peak count value of the difference histogram.

11. An image sensing device comprising:
a laser pulse transmitter configured to transmit laser pulses;
a reflected pulse receiver configured to receive reflected pulses generated when the laser pulses are reflected from an object;
a time information generator configured to generate first time information indicating a time elapsed from a first time to a reception time of the reflected pulse based on a first clock signal at a first phase and generate second time information indicating a time elapsed from a second time, which is subsequent to the first time, to a reception time of the reflected pulse based on the second clock signal at a second phase; and
a distance information generator configured to generate histograms based on the first time information and the second time information and generate distance information for the object based on the histograms.

12. The image sensing device according to claim 11, wherein the distance information generator is configured to:
generate a first preliminary histogram having the first time as a start point based on the first time information; and
generate a second preliminary histogram having the second time as a start point based on the second time information.

13. The image sensing device according to claim 12, wherein the distance information generator is configured to:
generate a combined histogram by summing the first preliminary histogram and the second preliminary histogram; and
generate the distance information based on the combined histogram.

14. The image sensing device according to claim 13, wherein the distance information generator is configured to generate the distance information using third time information corresponding to a bin having a peak count value of the combined histogram.

15. The image sensing device according to claim 11, further comprising:
a second clock signal selector configured to select a third clock signal among the clock signals,
wherein the time information generator generates the first time information indicating a time elapsed from the first time to a reception time of the reflected pulse based on the first clock signal and the third clock signal.

16. The image sensing device according to claim 15, wherein the first clock signal and the third clock signal have a phase difference of 90 degrees.

17. An image processing device comprising:
a division signal generator configured to generate division signals by dividing clock signals;
a pulse width controller configured to generate a first pulse width control signal and a second pulse width control signal;
a first multiplexer configured to select any one of the division signals based on the first pulse width control signal;
a second multiplexer configured to select any one of inverted division signals obtained by inversion of the division signals based on the first pulse width control signal;
a shift register configured to generate latch signals based on the second pulse width control signal, a selected division signal, and a selected inverted division signal;
a third multiplexer configured to select any one of the latch signals based on the first pulse width control signal;
an inverter configured to invert the selected latch signal;
an AND gate configured to output a pulse signal by performing a logical AND operation on the inverted latch signal and the second pulse width control signal;
a laser pulse transmitter configured to transmit laser pulses based on the pulse signal; and
a reflected pulse receiver configured to receive reflected pulses generated when the laser pulses are reflected from an object and generate image data based on the reflected pulses.

18. The image sensing device according to claim 17, wherein:
the AND gate is configured to output a first pulse signal and a second pulse signal;
the laser pulse transmitter is configured to transmit a first laser pulse based on the first pulse signal, and transmit a second laser pulse based on the second pulse signal;
the reflected pulse receiver is configured to receive a first reflected pulse generated when the first laser pulse is reflected from the object and a second reflected pulse generated when the second laser pulse is reflected from the object, and generate first image data and second image data based on the first reflected pulse and the second reflected pulse, respectively; and
the image sensing device further comprising a distance information generator configured to generate a first histogram based on the first image data, generate a second histogram based on the second image data, and generate distance information for the object based on a difference between the first histogram and the second histogram.

19. The image sensing device according to claim 18, wherein the pulse width controller is configured to:
change the first pulse width control signal based on the distance information such that each of a first pulse width of the first pulse signal and a second pulse width of the second pulse signal increases in proportion to a distance to the object.

20. The image sensing device according to claim 18, wherein the distance information generator is configured to:
calculate a difference between the first histogram and the second histogram;
generate a difference histogram for a difference pulse, which is a difference between the first reflected pulse and the second reflected pulse; and
generate the distance information using time information corresponding to a peak count value of the difference histogram.
